(19) United States
(12) Patent Application Publication
(10) Pub. No.: US 2024/0289844 A1
(43) Pub. Date: Aug. 29, 2024

(54) IN-VEHICLE ADVERTISEMENT PRESENTATION SYSTEMS AND METHODS

(71) Applicant: Ford Global Technologies, LLC, Dearborn, MI (US)

(72) Inventors: Himanshu Verma, Farmington Hills, MI (US); Fling Tseng, Ann Arbor, MI (US)

(73) Assignee: Ford Global Technologies, LLC, Dearborn, MI (US)

(21) Appl. No.: 18/173,511

(22) Filed: Feb. 23, 2023

(51) Int. Cl. G06Q 30/0251

(52) U.S. Cl. CPC G06Q 30/0266; G06Q 30/0269

(57) ABSTRACT

In-vehicle advertisement presentation systems and methods are disclosed herein. An example method includes determining vehicle information for a trip, the vehicle information including any one or more of a current vehicle location, a vehicle speed, a drive mode, and/or traffic information, determining user information, the user information including any one or more of a route prediction for the trip, a speed prediction for the trip, and/or a destination, determining user preferences for advertisements from any one or more of audio signals within the vehicle and/or historical user data, selecting a number of the advertisements to present to the user during the trip, and providing the advertisements to the user during the trip through a human-machine interface (HMI) of the vehicle.

### BACKGROUND

Advertisements can be presented to users in their vehicles through various means. For example, some advertisements can be presented visually and/or auditorily using an in-vehicle infotainment system or other similar human-machine interfaces (HMI). Advertisements can be presented through voice or audio systems in the vehicle. A user's preferences for advertisements can also be influenced by driving conditions or other contexts.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example environment in accordance with one or more embodiments of the present disclosure.

FIG. 2 illustrates an example flowchart of a method performed by a controller.

FIG. 3 is a flowchart of an example method of the present disclosure related to preference calculations.

FIG. 4 is a flowchart of another example method of the present disclosure.

FIG. 5 is a flowchart of an additional example method of the present disclosure.

### DETAILED DESCRIPTION

### Overview

Disclosed are systems and methods for personalized advertisement count based on user and vehicle awareness. Such systems and methods provide maximum opportunity for ad-based monetization. These systems and methods may use knowledge of vehicle destination prediction to provide more relevant advertisements, for example, if a user is going grocery shopping, merchandise purchasing, etc. Such systems and methods further provide the opposite force to a user's natural inclination to seek minimal or no ads. These systems and methods may intelligently schedule variable durations of ads, with playing time seeking to maximize company revenue while minimizing the impact on user experience. This is mainly a software implementation utilizing existing information from the vehicle, with no additional hardware involved.

It is noted that the systems and methods disclosed herein should be implemented in situations where such implementation can be done in a safe and reasonable manner. For example, if it is deemed undesirable or not allowed per local jurisdictional rules and/or regulations, the in-vehicle advertisement systems and methods disclosed herein should be disabled in the vehicle, manually or automatically. Also, a driver should not be looking at visual advertisements while the vehicle is moving. If implemented in the context of an autonomous vehicle, a person sitting in the driver's seat is a passenger during autonomous operation of the vehicle, and will be referred to as such herein. As used herein, “occupants” and “users” are passengers, not the person operating the vehicle while in motion.

Dependent personalized variables may be output from various prediction modules. A destination prediction may refer to a type of destination, e.g., work or a shopping mall, and may play a significant role in advertisement count. A route prediction may refer to a type of route, e.g., inner streets or freeways, a road class from a map provider, or as classified by speeds. The route prediction can have a direct impact on the number of advertisements. A speed prediction, e.g., high or low speeds, can impact a user's interaction with HMI for consuming advertisements. The level of speed may also have an impact on the primary workload. Passenger states may refer to a primary load as an occupant of the vehicle and a second load from operating IVI, brought-in devices, and/or voice controls. In general, a workload can include a number of ads for a determined context. The load can be divided into primary, secondary, or other subdivisions, where a primary workload of ads are presented for a first set of contextual information, and a secondary number of ads may be presented for a second set of contextual information. By way of example, if the vehicle is on a highway, a primary load may include presenting one visual HMI-presented advertisement to the passengers every ten minutes. User preferences may indicate that the passenger responds positively to audio advertisements, so a secondary workload may be more frequent such as presenting audio advertisements every five minutes.

An estimated remaining budget for the second load may be based on a target ad's count and relevance (where higher count ads are more tasking than low ones). A level of passenger interaction may be assessed from acoustic data. A user preference data may be used to understand the user's tolerance for a particular advertisement's count. The system can also learn historic user data to understand how many advertisements he/she interacts with via third-party apps or setup screen inputs with a store or item preference inputs. This historic user data can be tied to the abovementioned personal predictions. Dependent in-vehicle variables can include providing an optimal count of advertisements based on road or environmental conditions, a current vehicle speed, a drive mode, a vehicle location (e.g., freeway or internal streets), frequent routes, a passenger presence, and/or a traffic level (received from a content provider or inferred from a FORD BLIS system).

Personalized factors impacting an ad count can include a destination prediction, a route prediction, a speed prediction, a user preference, and/or a passenger state. Vehicle factors impacting an ad count can include a vehicle location, vehicle speed, traffic information, a drive mode, and/or a passenger presence. Operational space partition and preference learning may be used. Each condition can have its range estimated from learned values, and the estimate can be used to regulate the number (and relevance) of ads shown to the user.

Advantageously, the systems and methods disclosed herein provide maximized or optimized opportunities for ads-based monetization. Also, historical knowledge on vehicle destination prediction can be leveraged to provide more relevant advertisements if a user is going for grocery shopping, merchandise purchases, or other commercial endeavors. These systems and methods may provide an incentive to reduce a user's natural inclination to want minimal to no advertisements. The systems and methods also may provide for intelligent scheduling and playing time variability (e.g., differing durations) to maximize company revenue while minimizing the impact on user experience.

### Illustrative Embodiments

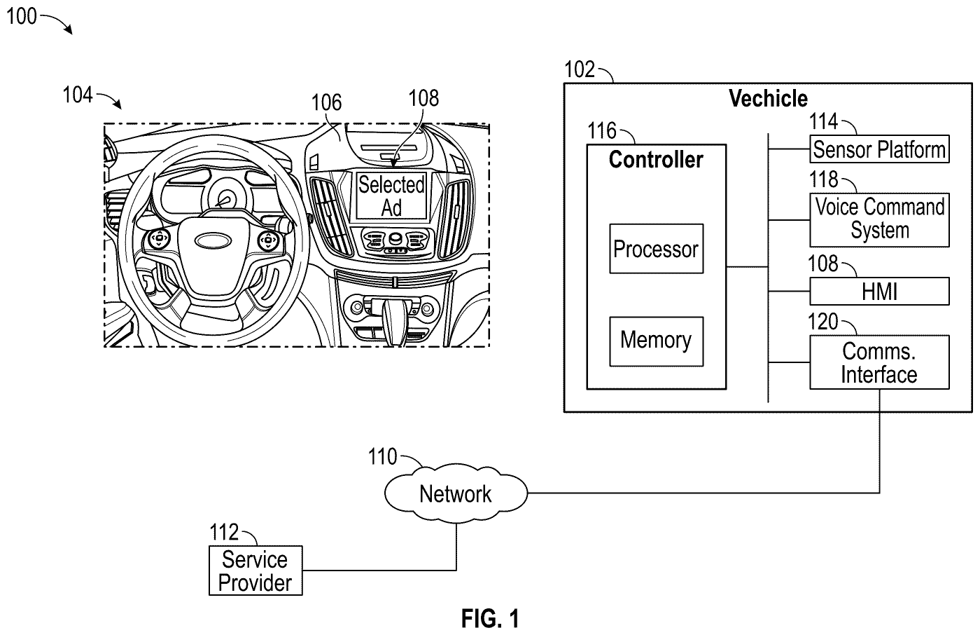

FIG. 1 illustrates an example environment where aspects of the present disclosure may be practiced. The environment includes a vehicle 102 having a cabin 104 or similar interior area. The cabin 104 can include a dashboard 106 having an HMI 108. The HMI 108 can have an in-vehicle infotainment system, a dedicated display, a digital instrument cluster, or other digital display. The vehicle 102 can couple with a network 110 to communicate with a service provider 112. The service provider 112 can include one or more remote resources from which the vehicle can obtain data such as map data, traffic data, or any other data disclosed herein. In addition, the operations of the controller 116 (described in greater detail infra), as described herein, may be performed at a remote server, such as the service provider 112. In these examples, contextual information, including user preferences can be gathered from a plurality of sources, such as a user's interaction with ads presented on the HMI, the user's interaction with ads presented on their mobile device, or from any other source of preference data that pertains to the user. These data can be collected and analyzed by the service provider 112 as described herein with respect to the controller 116. These advertisements and a schedule for playing such as to the user can be generated at the service provider 112 and transmitted over the network 110. The controller 116 can present the ads according to the schedule received from the service provider 112.

The network 110 may include any one or a combination of multiple different types of networks, such as cable networks, the Internet, wireless networks, and other private and/or public networks. In some instances, the network 110 may include cellular, Wi-Fi, or Wi-Fi direct. This network can include vehicle-to-vehicle communications, as well as vehicle-to-everything communications. Any suitable network may be used herein.

The vehicle 102 can comprise a sensor platform 114, a controller 116, a voice command system 118, and a communications interface 120 for connecting to the network 110. The sensor platform 114 can include any sensor that can collect vehicle-related data such as a current vehicle location, a current vehicle speed, vehicle drive mode, or any other vehicle operating data disclosed herein.

The controller 116 includes a processor and memory, and the memory stores instructions that can be executed by the processor. In general, the controller 116 can be configured to analyze data, such as contextual data, and present advertisements to a user, such as a passenger, through any of the vehicle systems such as the HMI 108 or the voice command system 118.

In some instances, the contextual data can include vehicle information, user information, and learned user preferences. Broadly, vehicle information can include but is not limited to, current vehicle location, current vehicle speed, drive mode, user presence, and traffic information. Each of the current vehicle location, current vehicle speed, and drive mode can be determined from the sensor platform 114. The controller 116 can obtain these data types from the sensor platform 114 and use the same in determining how many advertisements should be presented.

In one example, the current vehicle location can be used as a starting point for collecting some types of contextual information. For example, the vehicle may be co-located with the user's residence, their place of work, or any other location. When the location of the vehicle corresponds to a commercial location, such as a store or shopping mall, these data can be used to select a type and/or number of ads to present.

In some instances, the controller 116 can infer that advertisements should not be presented to a passenger when the vehicle is being operated in a school zone or in other similarly sensitive locations. When a passenger is present, the controller 116 may present a higher number of advertisements than would be presented based on user preferences due to the fact that the passenger can devote attention to the advertisements when the driver may not be able to, or may not have an interest based on driving conditions or driver preferences.

Current vehicle speed can also be used to determine the type and/or frequency of ads. For example, when the vehicle is being operated at high speeds, the frequency of ads may be reduced, especially when such ads are visual to not distract the driver. In another example, the type of ads selected for presentation by the controller 116 may include audio ads when the vehicle speed exceeds a threshold speed, in certain situations, like at night, in certain locations, etc.

With respect to drive mode, the controller 116 can be configured to detect the drive mode and adjust the number and/or type of ads presented to the user. For example, when the vehicle is in a comfort, eco, or other standard mode of driving, the controller 116 may infer that more ads can be presented as compared to when the vehicle is in an off-road or performance mode.

The controller 116 can also be configured to determine user presence and tailor the presentation of ads in response. For example, the controller 116 can determine user presence from in-cabin cameras, voice signatures, or other means. When a particular user is identified, the number and/or types of ads can be tailored to the specific preferences of the user(s) identified as being occupants in the vehicle. When multiple individuals are identified, the vehicle can present ads based on the preferences of each user. That is, the controller 116 can present a workload of ads to a first individual who has been identified as an occupant, and a second workload of ads to a second individual who has been identified as an occupant.

With respect to traffic information, the controller 116 can be configured to receive traffic information from a remote source such as the service provider 112. The controller 116 can adjust the number and/or type of ads based on traffic. When the vehicle is in stop and go traffic, the controller 116 can present more ads to the passengers due to the fact that the vehicle is moving more slowly resulting in the passenger being more open to receiving an advertisement. However, the user may not be comfortable viewing ads during high traffic times. Thus, the controller 116 may reduce the number of ads based on the user's preferences, even though the vehicle is moving more slowly. To be sure, the controller 116 can parameterize each of these inputs and use any or all in determining ad workloads, which can then be further adjusted based on user preferences. In sum, the controller 116 can select ad workload based on a balance between collected vehicle information and personal preferences of the user(s). User information can include user preference factors, such as a route prediction, speed prediction (based on a trip or route prediction), and destination prediction. A route or destination prediction can be made from navigation information. For example, if the user inputs a destination in the navigation system of the vehicle, the destination is explicitly known. The destination could be inferred from audio information. The controller 116 can also determine or infer the destination from historical driving data. For example, the controller 116 can infer that the vehicle is going to a grocery store when it is historical for the vehicle to go to a grocery store on Monday afternoons. Again, this is merely an example and is not intended to be limiting.

Route prediction can be inferred or determined based on the current vehicle location and direction, and/or the identified destination. For example, the controller 116 can determine road types that the vehicle will likely travel between the current vehicle location and the identified destination. This data can be obtained from the service provider 112 or information stored locally at the vehicle level, such as map data from a navigation system of the vehicle.

The vehicle operating mode can also be used by the controller 116 to increase or decrease advertisement presentation. For example, the controller 116 can select to present fewer ads when the vehicle drive mode is sport or off-road, where each of these modes indicates that the driver may be focusing more intently on driving and preferably should not be distracted by ads.

In some examples, long-duration interstate trips or inner street trips may require more or less attention, and thus, occupants of a vehicle in certain situations may not mind listening to longer duration advertisements or higher volumes of advertisements. Speed predictions can be made from the road types as well. For example, each road type or segment may have a known speed limit.

User preference data can also be used. These data can be determined from user interactions and behaviors. For example, the controller 116 may determine that the user silences or does not interact with advertisements when the speed of the vehicle exceeds a threshold speed. Thus, for some drivers, the preference may be that the controller 116 not present advertisements when driving at high speeds. However, the user may not object to the presentation of audio advertisements on certain types of trips (e.g., local errand or multi-hour trip). In sum, the controller 116 can selectively determine (or adjust) a number of advertisements presented based on context, which can include a combination of vehicle parameters/factors in combination with user preferences.

Regardless of the number and type of variables/conditions used from those discussed above, the controller can determine and enumerate a set of conditions. Each condition may have a range that can be estimated from learned values. These learned, estimated values can be used to regulate a number (and relevancy) of ads shown to the user.

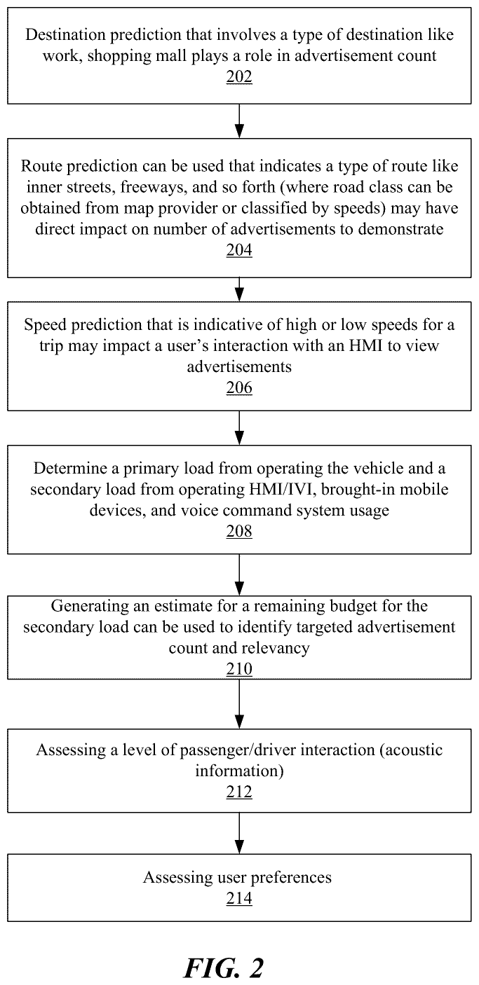

FIG. 2 illustrates an example flowchart of a method performed by a controller, such as controller 16. The controller 116 can present ads in a vehicle to occupants based on either or both of vehicle factors and dependent personalized variables. These variables can include a step 202 that involves a destination prediction that involves a type of destination like work, shopping mall plays a role in advertisement count. Any destination that involves a commercial endeavor or merchant can involve the presentation of more ads than if the destination is not commerce related.

A step 204 which involves route prediction can be used that indicates a type of route like inner streets, freeways, and so forth (where road class can be obtained from a map provider or classified by speeds), as well as the duration of the trip, that may have a direct impact on the number of advertisements to demonstrate. As noted above, the number of ads, or the length of a selected advertisement may be based on trip duration. For example, when the user has selected a destination that indicates a long trip, longer duration ads may be presented. Knowing the trip is likely to take an hour or more may allow for the presentation of ads that are longer in duration than ads presented for a shorter trip. In one example, ad duration for a cross-country trip might be five minutes in length compared to a duration of an ad selected for a 15-minute drive, which could be thirty seconds. Again, these are merely intended to be examples and are not limiting.

A step 206 can include speed prediction that is indicative of high or low speeds for a trip that may impact a user's ability to interact with an HMI to view advertisements. The level of speed may have an impact on the primary workload of ads presented. For example, the number of ads presented when the vehicle is operating on a highway may be greater than the number of ads presented when the vehicle is being driven in an urban area with high pedestrian counts. As noted above, the duration of these ads can be adjusted based on vehicle speed as well.

A passenger state step 208 can be used to determine a primary load from operating the vehicle and a secondary load from operating HMI/IVI, brought-in mobile devices, and voice command system usage. For example, the user may be presented with ads across various device and interfaces. The primary workload can account for the number and types of ads presented across these devices.

A step 210 of generating an estimate for a remaining budget for the secondary load can be used to identify targeted advertisement count and relevancy. It will be understood that higher count ads will be more tasking than low ones.

The method can include a step 212 of assessing a level of passenger interaction (acoustic information), as well as assessing user preferences in step 214. In one example, the controller may monitor user dialogue to detect when individuals are in a conversation. The number of ads may be intrusive if the individuals are engrossed in conversation. However, when the individuals are not in conversation, the number of ads presented can be increased. Thus, the level of interaction or conversation can be measured by detecting overlapping or frequent speech from individuals, and this data can be used to increase or decrease ad delivery numbers. In another example, when conversation is detected, visual or UI based ads may be presented rather than audio ads. Audio ads, or ads that include audio media may be reserved for situations where user dialogue is not detected for a selectable period of time, such as five minutes (other periods of time can be used).

The user's preferences can include metric data provided by the user, such as ads per mile, time of day, location, route, types of trip (for instance, long drive versus trip to medical care facility), and the controller learning historic user data to determine how many advertisements the user interacts with on a historical basis. Also, data from third-party applications or setup screen input preferences inputs can be used by the controller to make personal predictions of the number of advertisements that should be presented on a trip or route.

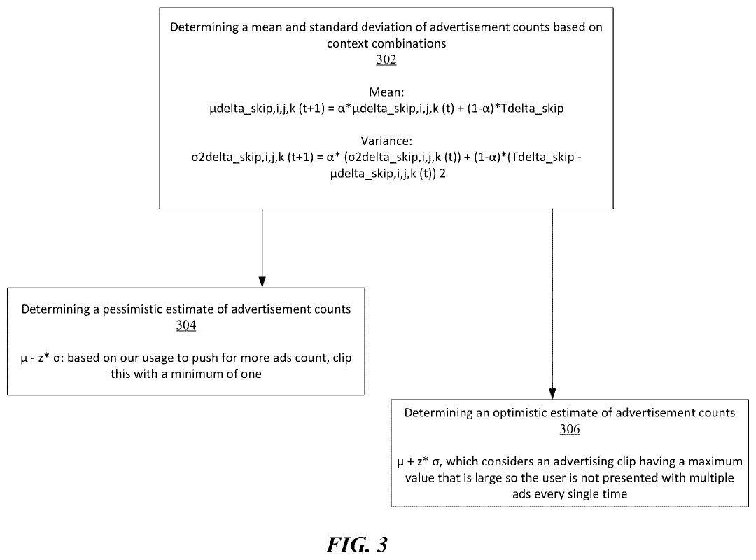

FIG. 3 illustrates an example flowchart of a method related to preference learning based on user feedback/input. The method can include a step 302 of determining a mean and standard deviation of advertisement counts based on context combinations. In some instances, the following equations can be used, where a mean update is calculated as follows:

$${μ}_{delta\_skip , i , j , k} ( t + 1 ) = α * {μ}_{delta\_skip , i , j , k} ( t ) + ( 1 - α ) * {T}_{delta\_skip}$$

and a variance update is calculated as follows:

$${σ}_{delta\_skip , i , j , k}^{2} ( t + 1 ) + {μ}_{delta\_skip , i , j , k} ( t ) = ( 1 - α ) * {( {T}_{delta\_skip} - {μ}_{delta\_skip , i , j , k} ( t ) )}^{2}$$

It will be understood that the variable u defines a mean value of a distribution and σ defines the spread of a distribution around the mean. The a is a number between 0 and 1 (usually very close to 1) that controls a moving window where the recursion updates the (μ, σ) one sample data at a time.

For example, if a is set to be 0.995, it is the equivalent of having a moving window of 1/(1−0.995)=1/0.005=200 data points. This equation above can be used to obtain (μ, σ) without the need to buffer the previous 200 data points. The pair of (μ, σ) can be used so that each person may have different u, which is the mean of acceptable duration to an advertisement, but also, people with the same u may actually have a different σ, which is the variability of the acceptable level of advertisement duration.

For example, in a conservative example, the system can pick an ad that fits the person and we choose z to be 1, which allows the system to select values differently for people even if their u values are the same. For a person that is highly variable in terms of what ad's he/she would desire to watch to completion, the system may choose to use “Even Shorter Ads” to ensure he/she will complete the ad.

In another example, the system can select a level of conservativeness such that the “Expected Probability” that the user will completely watch the ad is the same. In this case, two persons with the same u value but different σ values, when using the same z of 1, the duration will be different but the system is expecting both of them to complete the ad with same probability.

It will be understood that i, j, and k are encoding indices of impact factors such as vehicle speed range, presence of passenger, day/time, frequent routes, along with any of the other variables/conditions disclosed herein. It will be understood that z is a value that indicates how much variability can influence the count/duration of ads presented. This variability value can be learned over time from user behaviors/preferences. As z increases, the difference between the optimistic and pessimistic values may increase. To be sure, the equations above can be applied to each individual type of vehicle information or user preference parameter. Thus, each variable may have a unique set (μ, α) which can be used to produce a high dimensional data structure.

The method can include a step 304 determining a pessimistic estimate of advertisement counts. The pessimistic estimate can be calculated as follows: μ−z*σ→ based on our usage to push for more ads count, clip this with a minimum of one. The method can include a step 306 determining an optimistic estimate of advertisement counts. The pessimistic estimate can be calculated as follows: μ+z*σ, which considers an advertising clip having a maximum value that is large so the user is not presented with multiple ads every single time.

An optimistic estimate can be indicative of a duration or number of ads that the user is likely to enjoy based on user preference analysis. The pessimistic estimate may reflect what the user is likely to tolerate when they are not interested in hearing an ad created based on the optimistic estimate. In sum, the pessimistic estimate reflects what the user may tolerate in a worst-case scenario but the optimistic estimate is based on a best-case scenario. In one example, the optimistic scenario includes thirty second ads, but the pessimistic estimate includes five second ads. The system can titrate or vary between the optimistic and pessimistic versions of ads based on real-time user feedback. For example, when the user repeatedly terminates the playback of thirty second ads, the system can switch to five second ads and gauge user feedback thereafter. Thus, the mean is thirty seconds ads, but the variability can be as low as five seconds.

Also, these statistical analyses can be used to ensure that an individual is not presented with the same duration or type of ad too frequently. For example, the duration and types of ads can be varied to determine which ads are more preferred by a particular user. Positive and negative responses can be used to determine user preferences. For example, when a user turns down the volume when an audio ad is being presented, the system can learn that the user either does not like the subject matter of the ad or the user does not like audio ads. Differentiating between these two possibilities can occur as more data are collected. For example, the user may turn down the volume to not heat an audio ad from a merchant. Another ad for the same merchant is presented as an image on the HMI and the user positively interacts with the image. Thus, the system learns that the user likes the merchant or brand, but likely does not like the audio ad format. However, other information can be used to determine if the user generally dislikes audio ads or if the audio ad was presented at a time when the user was focused on a conversation. Again, these are merely examples and are not intended to be limiting.

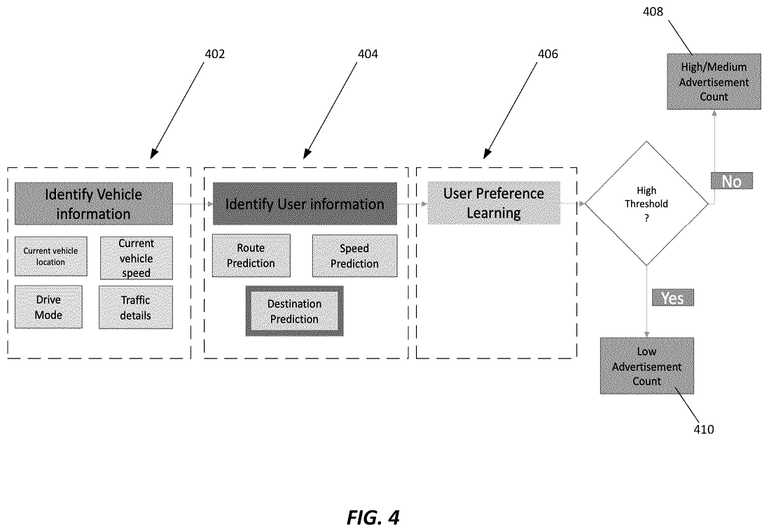

FIG. 4 is a flowchart of an example process for selecting the number of advertisements to present to a user while the user is riding in a vehicle. The method can include a step 402 of identifying vehicle information. In this example, the vehicle information can include combinations of a current vehicle location, a current vehicle speed, a drive mode, and/or traffic information. The method can also include a step 404 of identifying user information that can include a route prediction, a speed prediction, and/or a destination prediction. In some instances, the number of advertisements increases when the vehicle is in traffic, and the number of advertisements decreases as the vehicle speed increases. The various forms of information may be weighted, and it may be preferred to weight the predicted destination most heavily.

In step 406, the method can include learning user preferences from prior user engagements with the HMI or other vehicle features. User preferences can be obtained from various sources. For example, user preferences can be determined from a user profile created by the user. A user can create a user profile such as through a FORD PASS account/application. The user could define the types and/or duration of ads that they prefer. For example, one user may prefer visual-based ads over multi-media ads, whereas another user may prefer audio ads and select that no ads are to be displayed on their HMI.

In some examples, user preferences may be obtained from user interactions with ads. For example, if a user frequently closes ads presented on an HMI without interacting with the ads, the system can learn that the user does not prefer ads presented using the HMI. The system could learn that the user does not interact with ads presented during times where they are traveling through urban areas or when other occupants are present. In another example, the system can learn what types of ads annoy or irritate the user from keywords or phrases spoken by the user when ads are presented to them. Preferences for ads that the user likes or dislikes can also be inferred from user actions. For example, an ad may be presented on the HMI that requests that the user click a button or speak a word to receive a promo code. When the user completes the action as requested, the system can record such action as a positive behavior and user preference. User preferences for brands, merchants, and other subject matter can also be inferred from the types of ads that the user either positively or negatively interacts when presented during a trip.

The method can include a step 408 of determining when a high advertisement presentation threshold is met. That is, the system can determine when an ad count can be high or if it should be low, based on vehicle information and user preferences, which can include using the information obtained in steps 402-406. Step 408 includes establishing a high or medium ads count, whereas step 410 includes establishing a low ads count. Again, what constitutes low, medium, and/or high may depend on the preferences of the user(s) and/or the vehicle factors/information disclosed above. A high ad count can be confirmed when both the vehicle information and the user preferences indicate that more ads can be presented. For example, when the vehicle is being driven on a long trip (known from vehicle information such as navigation input) and a learned preference for the user indicates that they like long duration ads or a high volume of ads being presented during long trips, a high or medium ads count may be selected in step 408. Conversely, when the vehicle information and user preferences indicate that the user does not want a high or medium count of ads, a lower number of ads may be presented. Again, while ad count is a consideration, the type of ad selected can also be varied such as images, multimedia, audio, and so forth.

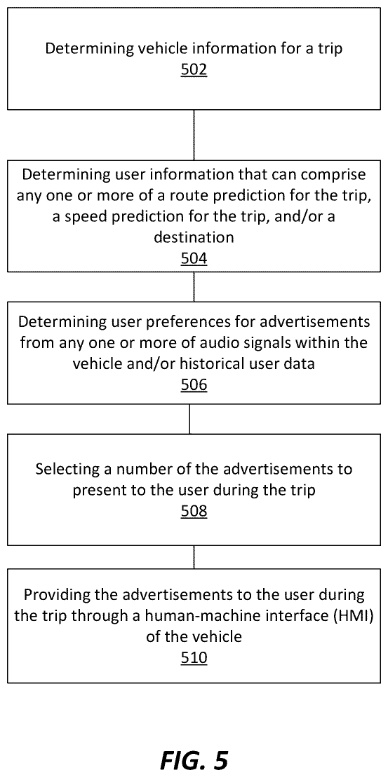

FIG. 5 is a flowchart of another example method of the present disclosure. The method can include a step 502 of determining vehicle information for a trip. The vehicle information can comprise any one or more of a current vehicle location, a current vehicle speed, a drive mode, and/or traffic information. These data can be gathered from on-board vehicle systems or from remote resources that can be accessed over a network.

The method may also include a step 504 of determining user information that can comprise any one or more of a route prediction for the trip, a speed prediction for the trip, and/or a destination. As noted above, the route prediction can be accomplished by identifying road-types from any one or more of a map service that identifies road classes or based on the vehicle speed. Knowledge of the destination can increase the number of advertisements when the destination pertains to commerce.

Additionally, the method can include as step 506 of determining user preferences for advertisements from any one or more of audio signals within the vehicle and/or historical user data. More details pertaining to the determination of user preferences are disclosed with respect to FIG. 3.

For example, this can include listening to conversations between occupants in the vehicle. The conversations can be parsed for keywords or phrases that may indicate where the occupants are traveling to. In some instances, historical user data is obtained from any one or more of a third-party application, setup screen inputs, and/or item preference inputs.

Next, the method includes a step 508 of selecting a number of the advertisements to present to the user during the trip, as well as a step 510 of providing the advertisements to the user during the trip through a human-machine interface (HMI) of the vehicle.

Step 508 can include an analysis that is similar to that disclosed above with respect to FIG. 3, such as determining a mean and standard deviation of advertisement counts based on context combinations, which can include both vehicle information and user preferences. In some instances, selecting the number of advertisements can include determining a primary load of the number of the advertisements and a secondary load based on any one or more of use of the HMI, a mobile device, and/or voice controls, as well as estimating a budget for the secondary load. Selecting a number of the advertisements to present to the user during the trip can also include calculating a mean and a standard deviation of advertisement counts. The analysis can also include determining both pessimistic and optimistic estimates of ad counts. A pessimistic ad count skews towards a fewer number of ads presented. In contrast, an optimistic estimate skews towards a higher number of ads being presented or instances where the ad presented has a long duration rather than multiple short ads.

Implementations of the systems, apparatuses, devices and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general-purpose computer, special purpose computer, or special purpose processing device to perform a certain function or group of functions. An implementation of the devices, systems and methods disclosed herein may communicate over a computer network. A “network” is defined as one or more data links that enable the transport of electronic data between computer systems and/or modules and/or other electronic devices.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method comprising:
determining vehicle information of a vehicle for a trip, the vehicle information comprising one or more of a current vehicle location, a vehicle speed, a drive mode, and/or traffic information;
determining user information, the user information comprising one or more of a route prediction for the trip, a speed prediction for the trip, and/or a destination;
determining user preferences for advertisements from any one or more of audio signals within the vehicle and/or historical user data;
selecting a number of the advertisements to present to the user during the trip; and
providing the advertisements to the user during the trip through a human-machine interface (HMI) of the vehicle.

2. The method according to claim 1, further comprising determining the route prediction by identifying road-types from one or more of a map service that identifies road classes, or based on the vehicle speed.

3. The method according to claim 1, further comprising determining the destination, wherein the destination increases the number of the advertisements when the destination pertains to commerce.

4. The method according to claim 1, wherein the number of the advertisements increases when the vehicle is in traffic.

5. The method according to claim 1, wherein the number of the advertisements decreases as the vehicle speed increases.

6. The method according to claim 1, further comprising:
determining a primary load of the number of the advertisements and a secondary load based on any one or more of use of the HMI, a mobile device, and/or voice controls; and
estimating a budget for the secondary load.

7. The method according to claim 1, wherein the historical user data includes information that is indicative of advertisements the user has interacted with, wherein the historical user data is obtained from any one or more of a third-party application, setup screen inputs, and/or item preference inputs.

8. The method according to claim 1, wherein selecting the number of the advertisements to present to the user during the trip includes calculating a mean and a standard deviation of advertisement counts.

9. The method according to claim 8, further comprising:
determining a pessimistic calculation of the number of the advertisements; and
determining an optimistic calculation of the number of the advertisements.

10. A system comprising:
a processor; and
a memory for storing instructions, the processor executing the instructions to:
determine vehicle information of a vehicle for a trip, the vehicle information comprising one or more of a current vehicle location, a vehicle speed, a drive mode, and/or traffic information;
determine user information, the user information comprising any one or more of a route prediction for the trip, a speed prediction for the trip, and/or a destination;
determine user preferences for advertisements from any one or more of audio signals within the vehicle and/or historical user data;
select a number of the advertisements to present to the user during the trip; and
provide the advertisements to the user during the trip through a human-machine interface (HMI) of the vehicle.

11. The system according to claim 10, wherein the processor is configured to determine the route prediction by identifying road-types from one or more of a map service that identifies road classes, or based on the vehicle speed.

12. The system according to claim 10, wherein the processor is configured to determine the destination, wherein the destination increases the number of the advertisements when the destination pertains to commerce.

13. The system according to claim 10, wherein the number of the advertisements increases when the vehicle is in traffic.

14. The system according to claim 10, wherein the number of the advertisements decreases as the vehicle speed increases.

15. The system according to claim 10, wherein the processor is configured to:
determine a primary load of the number of the advertisements and a secondary load based on any one or more of use of the HMI, a mobile device, and/or voice controls; and
estimate a budget for the secondary load.

16. The system according to claim 10, wherein the historical user data includes information that is indicative of the advertisements that the user has interacted with, wherein the historical user data is obtained from any one or more of a third-party application, setup screen inputs, and/or item preference inputs.

17. The system according to claim 10, wherein the processor is configured to select the number of the advertisements to present to the user during the trip by calculating a mean and a standard deviation of advertisement counts.

18. The system according to claim 17, wherein the processor is configured to:
determine a pessimistic calculation of the number of the advertisements; and
determine an optimistic calculation of the number of the advertisements.

19. The system according to claim 17, wherein the processor is configured to increase the number of the advertisements when the current vehicle location indicates that the vehicle is on a highway or freeway.

20. The system according to claim 17, wherein the processor is configured to intelligently schedule variable durations of the advertisements.
